(19) United States
(12) Patent Application Publication
(10) Pub. No.: US 2011/0227757 A1
(43) Pub. Date: Sep. 22, 2011

(54) METHODS FOR CONTEXT DRIVEN DISRUPTION TOLERANT VEHICULAR NETWORKING IN DYNAMIC ROADWAY ENVIRONMENTS

(75) Inventors: Wai Chen, Basking Ridge, NJ (US); Ratul K. Guha, Kendall Park, NJ (US); John Lee, Howell, NJ (US); Ryokichi Onishi, Kanagawa (JP); Rama Vuyyuru, Somerset, NJ (US)

(73) Assignees: TELCORDIA TECHNOLOGIES, INC., Piscataway, NJ (US); TOYOTA INFOTECHNOLOGY CENTER, U.S.A., INC., Mountain View, CA (US)

(21) Appl. No.: 12/724,623

(22) Filed: Mar. 16, 2010

(51) Int. Cl. H04B 7/00; G08G 1/00

(52) U.S. Cl. 340/902; 370/310

(57) ABSTRACT

A method and apparatus for optimizing communication of data within a disruption tolerant network. The method comprises of receiving a data packet, said data packet including a context and a state related to said context, storing the data packet to a buffer and disseminating the data packet to neighboring vehicles and RSU, and passing said state to an application, said application associated with said application context. In one embodiment, the method functions as a software protocol within a dashboard computer. The apparatus comprises a processor and a memory operable to receive a data packet, said data packet including a context and a state related to said context, store the data packet to a buffer when the context matches an application context, disseminating the data packet to neighboring vehicles and RSU, and pass said state to an application when the context matches an application context, said application associated with said application context. In one embodiment, the apparatus is presented as a dashboard computer within a vehicle.

### BACKGROUND

The present invention relates generally to an architecture for a disruption tolerant network, and more particularly to adaptation protocols for such networks in dynamic roadway environments.

A disruption tolerant network (DTN) connects nodes, such as onboard vehicular computer systems (sometimes also known as dashboard computers), in environments that may lack continuous network connectivity. A DTN often exists in a heterogeneous computing environment, i.e., the nodes and network topology are usually in a state of flux. For example, in a dynamic roadway environment, vehicles may constantly enter and leave the region covered by the DTN. One of the functions of a DTN is to route data from a source node to a destination node. This function may be complicated by a lack of interconnectivity between the source node and the destination nodes, i.e., intermediate nodes are unavailable within the DTN to forward the data towards its final destination. Another complication within a DTN arises from the timely receipt of data at the destination node, i.e., by the time data is received at the destination node its usefulness may have expired.

A dynamic roadway environment is an especially challenging type of DTN environment for the communication of data. Vehicles and their dashboard computers may communicate with other vehicles and roadside equipment/units (RSE/RSU) through wireless protocols such as 802.11a, 802.11b, 802.11 g, 802.11 p, 802.16, cellular technologies and the like. However, a dashboard computer functioning as a source node may be unable to determine if a routing path can be established between itself and a destination node. Often, a source node will indiscriminately broadcast its data hoping that the data will eventually reach the destination node.

Transmitting and storing messages in a DTN is highly inefficient. A dashboard computer may transmit data to another (neighboring) vehicle and dashboard computer heading away from the destination node. The data transmitted or requested by the dashboard computer may also be stale or irrelevant to the source node or the destination node after a period of time, and thus should be disregarded. The usefulness of data in a DTN is often based upon its context as well as its timeliness.

Thus, there is a need in the art for an architecture and protocols that optimize the communication of data within a DTN. The architecture needed is a context driven architecture that provides relevant data (information) to a node such as a dashboard computer. Further, the data provided to the node is current, i.e., not expired, and capable of being processed by the node and further used by one or more applications or forwarded on towards a destination node.

### SUMMARY OF INVENTION

A method for optimizing communication of data within a disruption tolerant network is presented. The method comprises receiving a data packet, said data packet including a context and a state related to said context, storing the data packet to a buffer when the context matches an application context, and passing said state to an application, said application associated with said application context. In one example, the state may consist of the traffic congestion level in a certain region, i.e., the roadways. In one embodiment, the method functions as a software protocol within a dashboard computer.

In another aspect, an apparatus for optimizing communication of data within a disruption tolerant network is presented. The apparatus comprises a processor and a memory operable to receive a data packet, said data packet including a context and a state related to said context, store the data packet to a buffer when the context matches an application context, and pass said state to an application, said application associated with said application context. In one embodiment, the apparatus is presented as a dashboard computer within a vehicle. In another embodiment, the apparatus resides as a computer within a roadside unit.

A computer-readable medium employing the method is also provided.

### BRIEF DESCRIPTION OF DRAWINGS

FIG. 1 is a dynamic roadway environment in which the present invention can be utilized;

FIG. 2 is an overview of information flow between system components within the dynamic roadway environment;

FIG. 3 is a logical communication architecture for the invention;

FIG. 4 is a functional stack architecture for the invention;

FIG. 5 is an example of a DTN packet;

FIG. 6 is an example of an application interface module;

FIG. 7 is an example of a packet generation module;

FIG. 8 is a flow diagram of the functioning of the content optimization sub-layer;

FIG. 9 is a flow diagram of header processing triggered by an incoming data packet and the sending of an acknowledgement upon receipt of the data packet;

FIG. 10 is a flow diagram of one embodiment of the functioning of the detection and condition module;

FIG. 11 is a flow diagram of another embodiment of the functioning of the detection and condition module;

FIG. 12 is a flow diagram of another embodiment of the functioning of the detection and condition module;

FIG. 13. is a flow diagram of a method for forwarding a data packet from a vehicle;

FIG. 14 is a flow diagram of a method for forwarding a data packet from one RSU to another RSU;

FIG. 15 is a flow diagram of a method for updating the carrying buffer;

FIG. 16 is a flow diagram of one embodiment of a method for updating the carrying buffer upon receipt of an acknowledgment message for a single dissemination transmission;

FIG. 17 is a flow diagram of a method for retransmitting a packet when the acknowledgement timer expires;

FIG. 18 is a flow diagram of one embodiment of a method for updating the carrying buffer upon receipt of an acknowledgment message for a repetitive dissemination transmission;

FIG. 19 is a flow diagram of a method for retransmitting a packet when the acknowledgement timer expires;

FIG. 20 is an example of how tags are used in content anchoring;

FIG. 21 is an example of how the present invention can function in a dynamic roadway environment; and

FIG. 22 is one embodiment of a dashboard computer system.

### DETAILED DESCRIPTION

A method and system, particularly an architecture and protocols, for optimizing a DTN are described herein. The invention is described within the context of a dashboard computer in a vehicle (automobile) communicating data between other vehicles and their dashboard computers, roadside equipment (RSE) and roadside units (RSU). In one embodiment of the invention, the data includes information about traffic conditions and congestion in a geographic location. The innovative protocols optimize and eliminate redundant information provided to the dashboard computer. It is understood that the invention and general concepts described herein may benefit any general computer network.

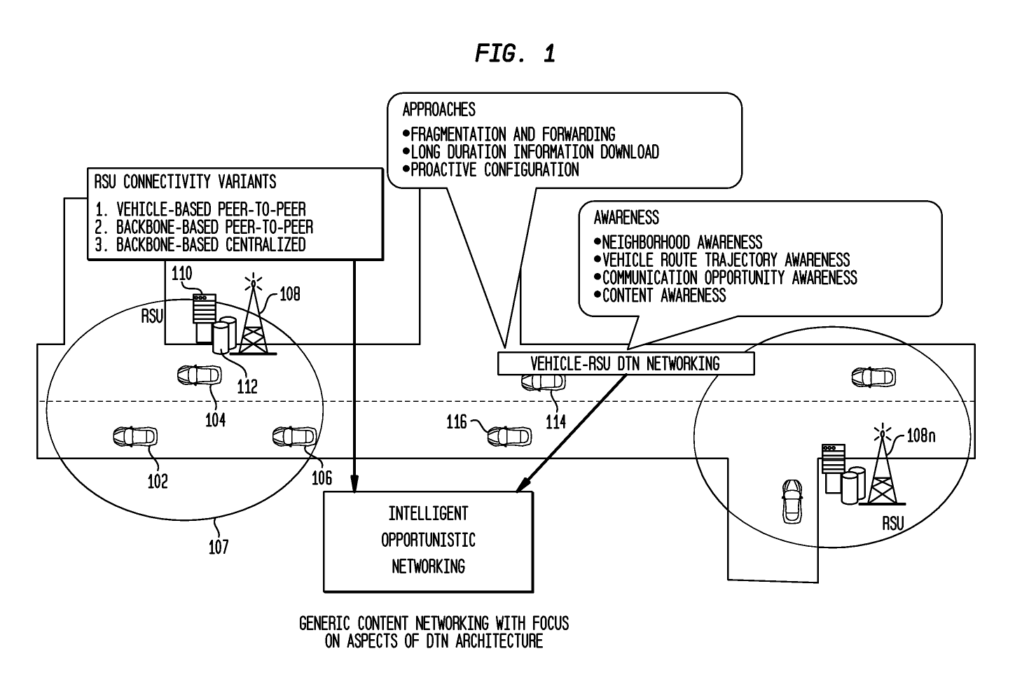

FIG. 1 is an overview of a dynamic roadway environment which can benefit from the present invention. The environment includes vehicles 102, 104 and 106 all within communication range of each other as indicated by shaded region 107. A roadside unit (RSU) 108 is also present and in communication with the vehicles in the region 107. The RSU 108 is coupled to a server 110, and the server 110 is coupled to a data storage device 112. The server 110 and data storage device 112 may be locally connected to the RSU 108, or remotely connected to the RSU 108 by the Internet or any common network protocol.

The RSU 108 is a device that communicates information, such as traffic information, road conditions, weather information, or any other information related to the region 107 in which it is located. The RSU 108 communicates information to vehicles wirelessly, and may also communicate to other RSUs through wired communication links. The information is generally provided to the RSU 108 by the server 110. RSUs may also obtain information through roadside sensors. The RSU 108 may be a standalone unit along the side of the road, attached to a traffic device, e.g., a traffic light, or attached to a traffic sign. Often, the RSU 108 is located at an intersection or other high volume vehicle area to maximize the number of vehicles that receive its communications. In some embodiments, the RSU 108 is capable of two-way communication, receiving information from other RSUs and from the dashboard computers of passing vehicles. As shown in FIG. 1, the RSU 108 communicates wirelessly with the vehicles 102, 104 and 106 forming a peer-to-peer (ad hoc) network within region 107.

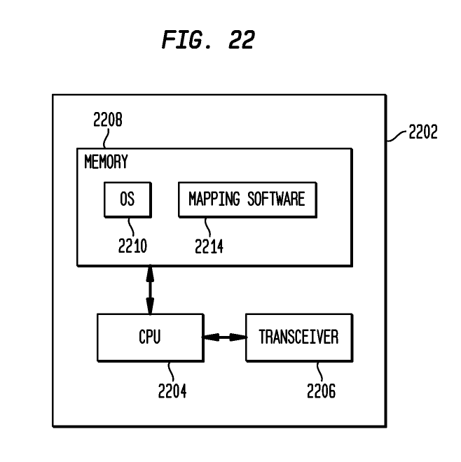

Dashboard computers (as shown in FIG. 22) in any of the vehicles may request information from other vehicles and the RSU 108, or vehicles and the RSU 108 may broadcast information about the region 107 to each other. In one embodiment, the dashboard computer is aware of its location (through GPS or other positioning means), the vehicle route and trajectory, the opportunity to communicate its data to other passing vehicles or RSUs, and the type of content stored by the dashboard computer that is available for broadcast. The opportunity to transmit data between vehicles and RSUs is often limited by time, therefore dashboard computers must be able to select only the most relevant or useful data for communication.

As shown in FIG. 1, there are two vehicles 114 and 116 not within any of the shaded regions. Assume that vehicles 114 and 116 have just passed through the shaded region covered by RSU 108n and are headed towards region 107. Once vehicles 114 and 116 enter region 107, these vehicles may communicate data such as traffic information or road conditions provided by RSU 108n to vehicles 102, 104 and 106. If any one of the vehicles 102, 104 and 106 are headed towards the region covered by RSU 108n, their dashboard computers will be capable of alerting the driver to the roadway conditions ahead and possibly selecting an alternate route if necessary.

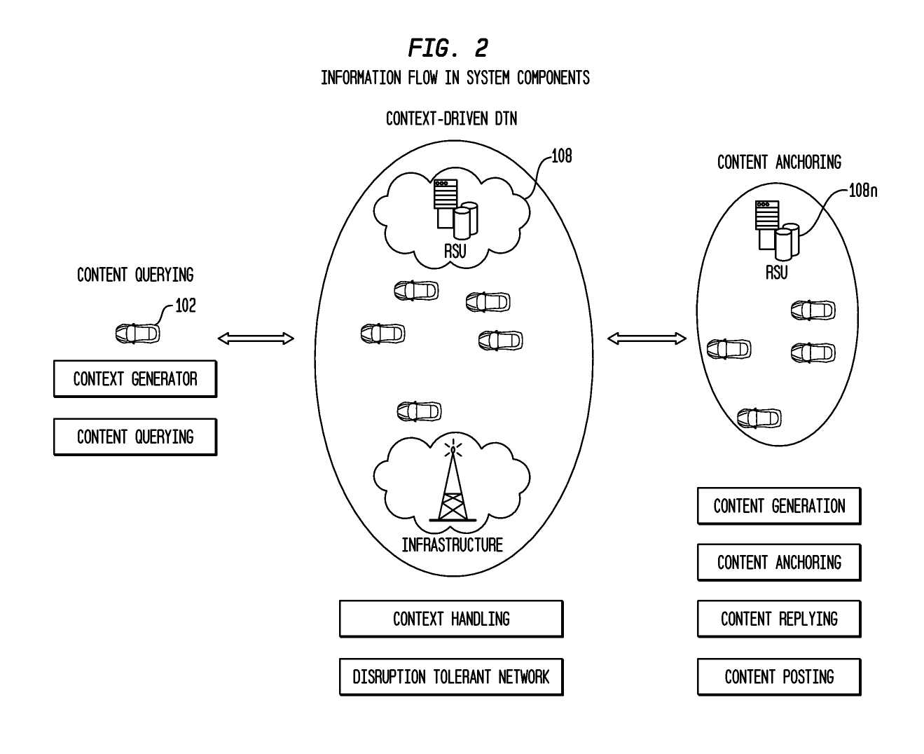

FIG. 2 is an overview of information flow between system components within a context driven DTN. A vehicle 102 generates a context from an application and a query related to the context. The vehicle 102 queries other vehicles and road side equipment or an RSU 108 for information based upon the “context” required by one or more applications running on a dashboard computer within the vehicle 102. In one aspect, context refers to application-specific parameters related to time and space associated with the vehicle's travel route. A destination region, an estimated time of arrival, or estimated travel times are all examples of context. For example, the context may include calculating the fastest route between the present location of the vehicle 102 and a destination. The RSU 108 and other vehicles may collect information from many other vehicles through roadside sensors and wireless communication with the dashboard computers of other vehicles capable of communicating with the RSU 108. The RSU 108 may also collect additional information from other RSUs.

An RSU 108 and vehicles that function as content anchors provide at least the following four functionalities: content generation, content anchoring, content replying, and content posting. Content generation is the creation of information based upon collected information from one or more sources. For example, an RSU 108 capable of monitoring traffic congestion may generate information about the level of traffic congestion within the region surrounding the RSU 108 and also share that information with other vehicles. Content anchoring is the association of information to a particular geographic location wherein the infatuation may be disseminated to and stored on dashboard computers of vehicles currently in that particular geographical region or within an RSU in that particular geographical region. For example, an RSU located along an area of highway may store and disseminate information about ongoing road work along the highway. In another example, in each geographical region of interest, each vehicle that has the content disseminates such packets in the non-trajectory mode and within the geographical region of interest. This increases the likelihood of having the content available to nodes within the geographical region of interest.

Content replying and content posting are related to the dissemination of information between vehicles and RSU 108 to other RSUs and vehicles. A content reply is made in request to a content query. As shown in FIG. 2, a vehicle 102 makes a content query to the RSU 108 and other surrounding vehicles. The RSU 108 or vehicles that have the content available reply with an appropriate message as discussed in further detail below. Content queries may be initiated by application software, such as GPS or mapping software, within the vehicle 102. Content posting is the dissemination of information, such as traffic congestion information, accident warnings, roadway condition information, etc., that may be of use to passing vehicles and other RSUs. Such information is made freely available to all vehicles and RSUs.

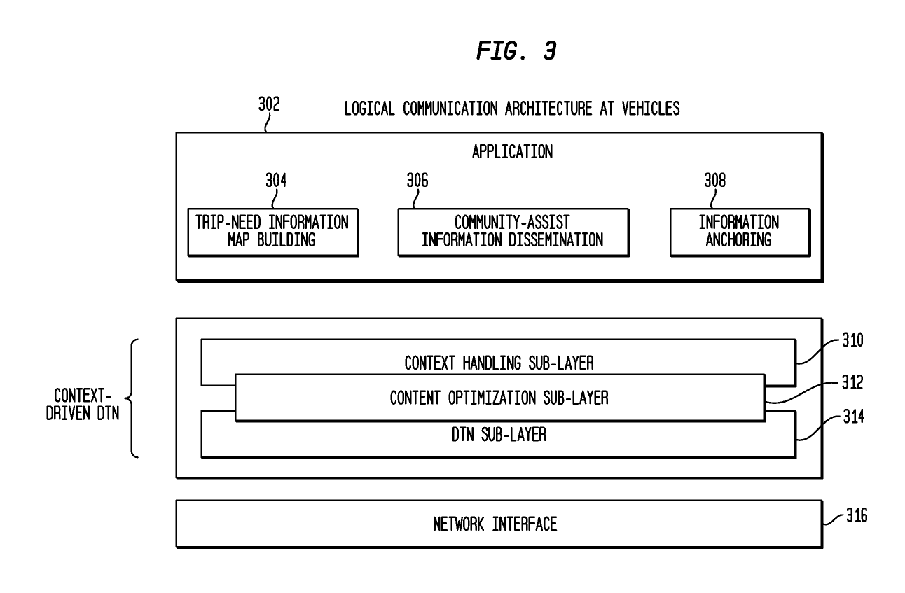

FIG. 3 is an overview of the logical communication architecture within a dashboard computer. The dashboard computer is a computer that comprises a memory and a processor and is capable of communicating with other dashboard computers and RSUs. An example of a dashboard computer is described in further detail in FIG. 22.

The architecture comprises an application layer 302 sitting on top of a context handling sub-layer 310, a content optimization sub-layer 312 and a DTN sub-layer 314. The application layer 302 includes the user interface (not shown), which is often a graphical user interface (GUI). As examples, three applications are shown running within the application layer 302; they are a “trip-need information map building” application 304, a “community-assist information dissemination” application 306, and an “information anchoring” application 308. Applications such as the “map building” application 304 are initiated by the user. Other applications such as the “information dissemination” application 306 and “information anchoring” application 308 generally run in the background.

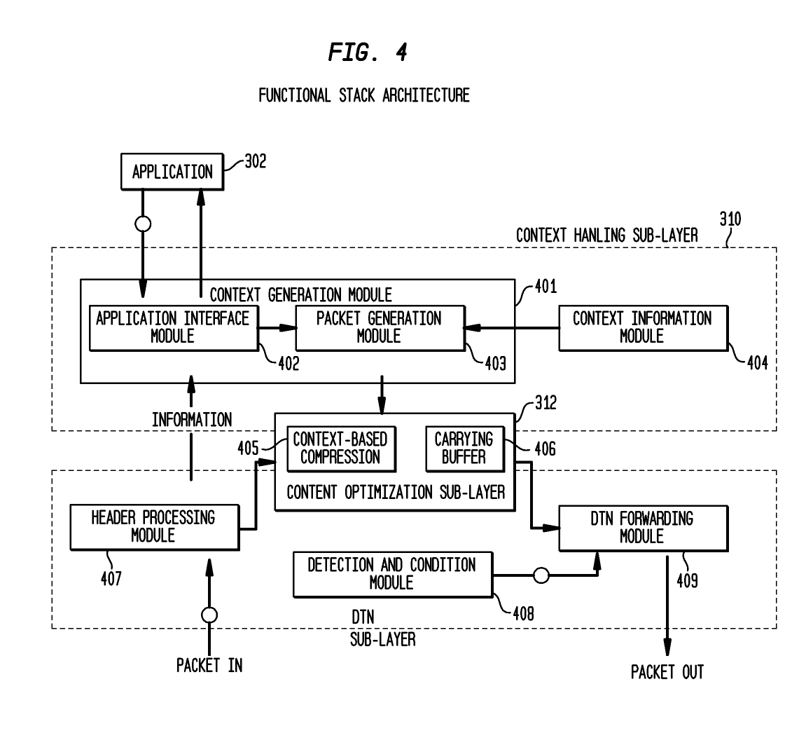

The DTN sub-layer 314 is responsible for the assembly, parsing, transmission, and reception of data packets. The DTN sub-layer 314 is coupled to a network interface (NIC) 316. The NIC 316 allows the dashboard computer to communicate with other dashboard computers and RSUs. In one embodiment, the NIC 316 supports wireless communication via a standard such as the 802.11a communications protocol. The functions of the different sub-layers are explained in further detail in FIG. 4.

FIG. 4 provides a more detailed view of the logical communication architecture shown in FIG. 3. The application e.g., 304, 306 or 308, remains coupled to the context handling sub-layer 310. The context handling sub-layer 310 comprises a context generation module 401 and a context information module 404. The context generation module 401 further comprises an application interface module 402 and a packet generation module 403.

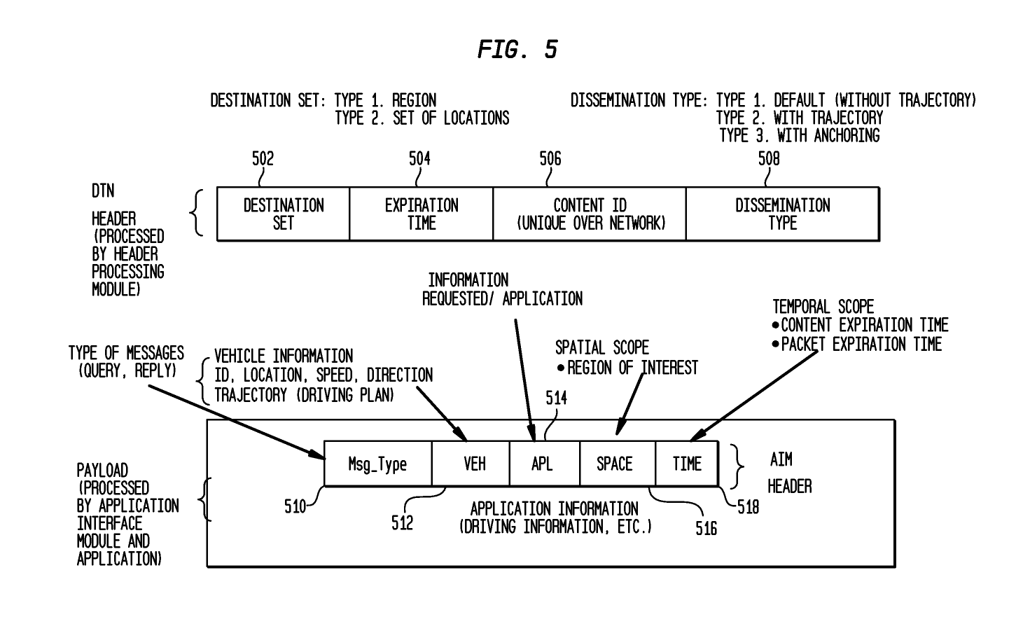

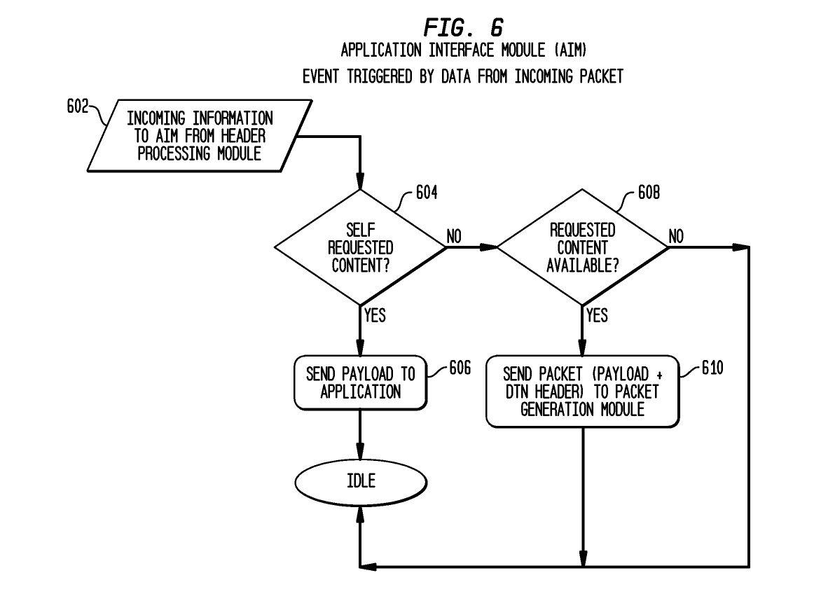

The packet generation module 403 receives information (data) from the context information module 404 and the application interface module 402. The information supplied by the context information module 404 may include data about the vehicle's speed and trajectory, final destination, road conditions, and information forwarded to the vehicle from other vehicles and RSUs, etc. The application information module 402 may supply one or more queries or replies for information from other vehicles and RSUs to the packet generation module 403 as shown in FIG. 7. In one embodiment, the packet generation module 403 composes a data packet as shown in FIG. 5 in accordance with the method shown in FIG. 7.

Referring now to FIG. 5, one example of a DTN packet is provided. The DTN packet comprises a header and a payload. The header comprises a destination set 502, an expiration time 504, a content identifier 506, and a dissemination type 508. The payload comprises a message type 510, i.e., query or reply, vehicle information 512 which may include a vehicle identifier, speed, direction, and a trajectory (routing information), an application identifier 514, a region of interest identifier 516, and a time stamp 518.

The destination set 502 includes one or more bits that indicate a region or set of locations that relate to the information in the payload. For example, the destination set 502 may indicate the information relates to a region such as region 107 in FIG. 1. The expiration time 504 indicates an amount of time for which the payload is valid. In some embodiments, the expiration time is measured in seconds or minutes. For example, a particular payload may expire after 120 seconds (2 minutes). Once the payload has expired, it is discarded by the dashboard computer system and no longer forwarded across the network. The use of an expiration time 504 helps to ensure that expired data is not forwarded or received.

The content ID 506 is a unique identifier that distinguishes the content of a data packet from all the other data packets in a network. For example, the content identifier could be the name of the cross streets comprising an intersection appended to the word traffic, e.g., traffic-crosstreet1-crosstreet2. The dissemination type 508 indicates how the data packet should be disseminated from a source node (dashboard computer) to a destination node. In one embodiment, there are three possible types of dissemination: 1) Broadcast without trajectory; 2) Broadcast with trajectory; and 3) Content anchoring.

A broadcast without trajectory transmission broadcasts the data packet to all available neighboring nodes, i.e., vehicles and RSUs, within the vicinity of the source node. A broadcast with trajectory transmission also broadcasts the data packet to all available nodes, i.e., vehicles and RSUs, within the vicinity of the source node. However, in the case of broadcast with trajectory, the source node includes trajectory information in the data packet. If the recipient node is headed along the proper trajectory, i.e., towards a certain destination point or region, then the recipient node retains the data packet. However, if the recipient node is headed away from the destination point or region indicated by the trajectory information, then the recipient node discards the data packet i.e., excludes itself from forwarding the packet in a self-selective fashion. Both the source node and the recipient node need an awareness of their locations and their trajectories, which may be provided by GPS units coupled to the dashboard computers, for this type of dissemination to properly function. An anchoring transmission ties a data packet to a specific geographic location or region. Again, the source node must have an awareness of its location. As an example, referring back to FIG. 1, an anchoring transmission occurs if vehicle 102 broadcasts a data packet only when it is within region 107. Typically, an anchoring transmission is used to transmit information specific to a localized area.

The payload which is processed by the application interface module 402 comprises several fields, including ‘message type’ 510, vehicle information 512, the application identifier 514, the region of interest identifier 516, and one or more timestamps 518. The ‘message type’ 502 indicates whether data packet is a reply or a query. A vehicle may request data, in which case the message type 510 is set to query, and a vehicle may also reply to a query from another vehicle, in which case the message type 510 is set to reply. In one embodiment, vehicle information 512 includes a unique vehicle identifier, vehicle location, speed, direction, and trajectory (driving plan which includes the current speed, direction and routing information for the vehicle). The application identifier 514 indicates which software application at the application layer 302 is providing or requesting the information stored in the data packet. For example, the map application 304 may request traffic information and road condition information about a region surrounding a destination.

The region of interest identifier 516 may be set to indicate the geographical region and the physical size of the area surrounding the geographical region. For example, if the data packet includes information about traffic congestion, and the vehicle broadcasting the data packet has been moving at a slow speed for several miles, then the region of interest identifier 516 could be set to indicate a region of interest several miles wide. In some embodiments, the region of interest identifier 516 is the area immediately surrounding the location of a vehicle. In other embodiments, when a vehicle is functioning as an intermediate node and retransmitting a data packet from a source node to a destination node, the region of interest is remote to the vehicle. The region of interest identifier 516 may be used by applications such as a map application to display traffic congestion and road-condition information on a map. The region of interest identifier 516 may also be used by a GPS and a routing program to route a vehicle away from heavily congested regions.

The one or more timestamps 518 may include a content expiration time and a packet expiration time. The use of timestamps 518 helps maintain the freshness and validity of a data packet. When a timestamp exceeds a threshold value, i.e., the timestamp indicates the data packet is expired, a node discards the data packet bearing the expired timestamp. A dynamic roadway environment is usually an extremely fast paced, constantly changing environment. In some embodiments, the nature of the extremely fast paced environment is reflected by expiration times on the order of milliseconds or seconds.

Referring back now to FIG. 4, data packets are stored in a carrying buffer 406. The data packets stored in the carrying buffer 406 are subject to optimization by “context-based compression” module 405. The “context-based compression” module 405 is software that reduces or eliminates redundant or highly similar data packets from the carrying buffer 406.

The “context-based compression” module 405 employs a set of rules to perform context-based compression. In one embodiment, for example, if the carrying buffer 406 contains multiple data packets such as shown in FIG. 5, and all of the data packets relate to traffic congestion information within the same region as identified by region of interest identifier 516, then the compression module 405 may discard all the data packets and only retain the most recent data packet as indicated by the timestamp 518. In other embodiments, the compression module 405 aggregates or merges information stored in multiple data packets.

Referring now to FIG. 6, a method for how the AIM 402 interfaces with the packet generation module 403 is provided. At step 602, information is provided to the AIM 402 from the header processing module 407. At step 604, a determination is made as to whether or not the content is self-requested by an application such as 304, 306 or 308 at some earlier point of time. For example, map building application 304 sends a query for content identified as ‘X’. When the content ‘X’ is received at a later point in time, the content is self-requested and sent to the map building application 304. If the content is self-requested, it is sent to the application at step 606. Otherwise, the method proceeds to step 608. At step 608, a determination is made as to whether the requested content is available. If the requested content is available, the content is sent to the packet generation module 403 at step 610.

Referring now to FIG. 7, one example of the functioning of the packet generation module 403 is provided. The packet generation module 403 composes data packets upon receiving data from the AIM 402. At step 702, the AIM 402 receives data from the application software 302 and provides the received data to the packet generation module 403. At step 704 the presence of a DTN header is checked for by the packet generation module 403. If a DTN header is already present, then the method proceeds to step 710. At step 710, the DTN header is updated with the destination set from the AIM header. If a DTN header is not present, then the method proceeds to step 706. At step 706, an AIM header (as shown in FIG. 5) is appended to the data packet. At step 708, a DTN header (as shown in FIG. 5) is also appended to the data packet. At step 712, the data packet is stored in the carrying buffer 406. At step 714, the DTN timer for the data packet is started. The data packet remains in the carrying buffer 406 until the DTN timer expires, or until another event such as the expiration of an ACK timer causes the data packet to be discarded from the carrying buffer 406.

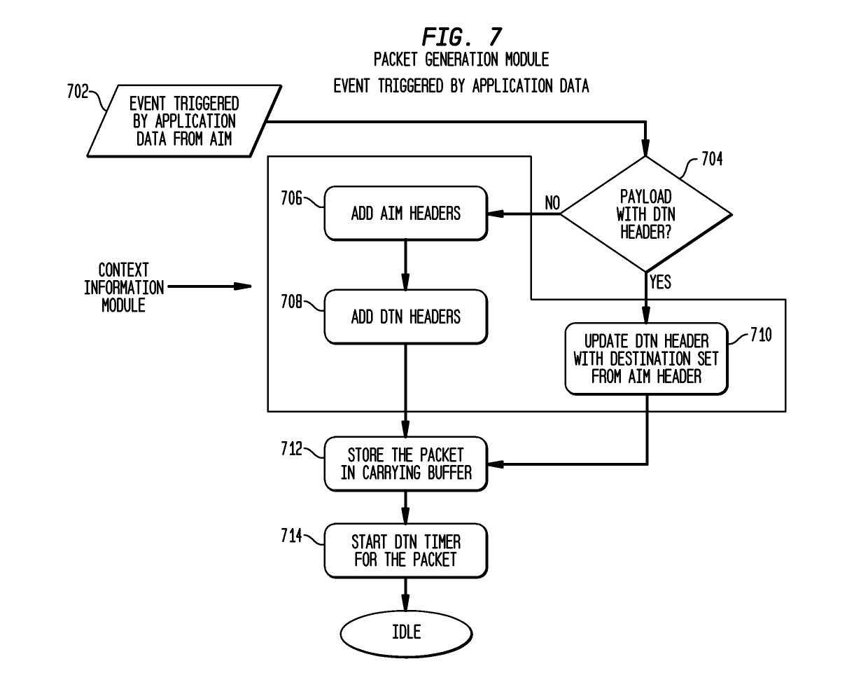

Referring now to FIG. 8, an example of a method for data compression within the content optimization sub-layer is provided. The method begins at step 802 when an event triggers the carrying buffer 406 to update itself. In one embodiment, a triggering event is the receipt of a new data packet into the carrying buffer 406. The buffer itself is a memory that stores data packets received from other vehicles and RSUs. The data packets within the buffer may also be generated from applications within the dashboard computer. At step 804, packets with redundant content and destination redundancy are eliminated. As an example, assume several data packets are received from vehicles and RSUs and the data packets contain information about traffic congestion around a destination region. If all of the data packets contain similar information, then all but one of the data packets is discarded. In one embodiment, the traffic congestion information stored in the data packet is characterized by levels such as high (H), medium (M) and low (L). These levels can be represented by bit values within the data packet. Relating to the present example, if all of the data packets in the carrying buffer 406 indicate the same level of traffic congestion around the destination region, e.g., high, then only one data packet is required to provide traffic information and the remaining data packets within the buffer are discarded because they are redundant.

At step 806, context based compression is performed on the remaining data packets in the carrying buffer 406. The context based compression may be performed by merging values or using codebooks. As an example, the data packets may contain information about traffic congestion around a destination region, but the levels of traffic congestion may differ. For example, several data packets may indicate a low level of traffic congestion around the destination region, while other data packets may indicate a high level of traffic congestion around the destination region. The level of traffic congestion is represented by one or more bits within each data packet. In one embodiment, the level that these bits represent may be averaged together to provide the average level of traffic congestion around the destination region. In another embodiment, a data packet is only stored and forwarded when a level or state change occurs. For example, if there are four data packets within the carrying buffer, and the four data packets store information about traffic congestion, e.g., three data packets indicate low or ‘L’ levels of traffic congestion and one data packet indicates high or ‘H’ level of traffic congestion, only two of the data packets indicating differing levels of traffic congestion, i.e., ‘L’ and ‘H’, are stored and transmitted. These two data packets indicate a change in level of traffic conditions (from ‘L’ to ‘H’ or ‘H’ to ‘L’ depending upon the other information within the data packet). It is understood that traffic congestion levels may be represented by values other than L, M and H. For example, a number scale between 1 and 10, where 1 is the lightest amount of traffic congestion and 10 is the heaviest amount of traffic congestion may be used as levels. At step 808, the data packets are randomized in the carrying buffer 406. The method proceeds to step 810, where the content optimization method becomes idle until another event trigger causes the optimization process to start over. Randomization helps to improve fairness between packet transmissions. Without randomization, head of the line packets, i.e., those at the front of the queue in the carrying buffer 406, are sent repeatedly while other packets are sent less often.

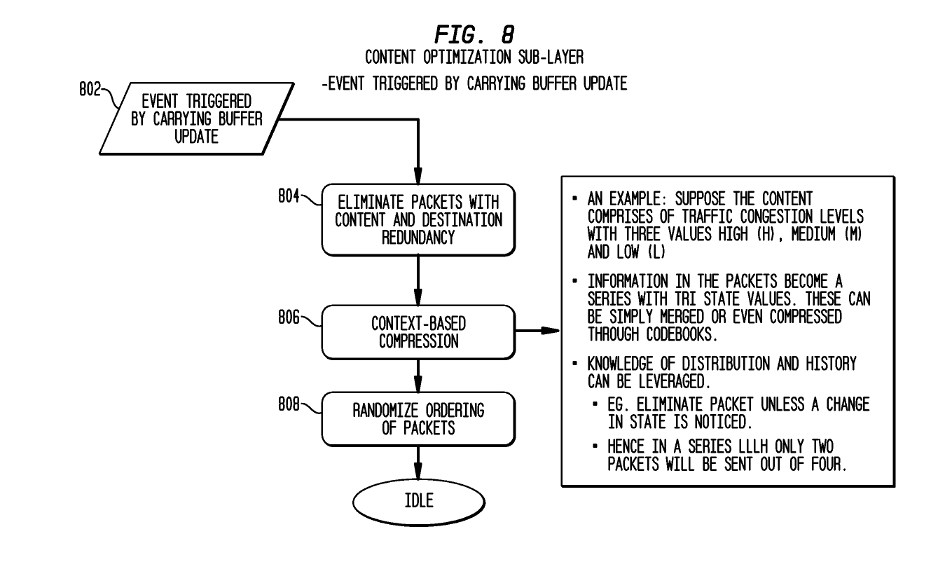

FIG. 9 is a method for processing the header of an incoming data packet. The header is processed by software at the DTN sub-layer. The method starts at step 902, when a packet arrives at the network interface 316. At step 904, a determination is made as to whether or not the data packet is new. Data packets may take multiple paths over the wireless network between multiple vehicles and RSUs, and there is a possibility that duplicate data packets will arrive. The header of the data packet is parsed, and if the data packet is not new, i.e., a duplicate version is already stored in the carrying buffer 406, then the data packet is discarded. In one embodiment, the data packet may be identified by a unique data packet identifier stored in the header. In another embodiment, a bitwise comparison between the bits stored in the received data packet to the data packets stored in the carrying buffer 406 reveals whether or not the data packet is new. If the data packet is not new, then the method proceeds to step 908 and the data packet is discarded. If the data packet is new, i.e., does not exist in the carrying buffer 406, then the method proceeds to step 906.

At step 906, a determination is made as to whether or not the content stored in the data packet is expired. Recall from FIG. 5 that each data packet includes an expiration time field 504 for storing a time value to ensure the temporal currency (freshness) of the data. In one embodiment, if the expiration time exceeds a threshold value then data packet is expired and the method proceeds to step 908. At step 908, the expired data packet is discarded. If the data packet is not expired, then the method proceeds to step 909.

At step 909, a determination is made about the dissemination type (trajectory, non-trajectory etc.) from field 508. In one embodiment, trajectory information includes not only the speed and direction of the vehicle, but also routing information, including waypoints between a vehicle's current position and its final destination. If the mode in 508 is set to ‘without trajectory’, then the received data packet has been indiscriminately broadcast from another vehicle or RSU and the method proceeds to step 912. At step 912, an acknowledgment or ‘ACK’ message is sent from the vehicle that received the data packet to the sender of the data packet, i.e., another vehicle or RSU. The ‘ACK’ message is received at the sending vehicle or RSU and indicates that the data packet has been transmitted and received by at least one other vehicle, i.e., a node, on the network. At step 914, the data packet, as shown in FIGS. 6 and 7, is stored in the carrying buffer 406.

At step 916, the DTN timer is started after the received data packet is written to the carrying buffer 406. Once the value of the DTN timer exceeds the value stored in the expiration time field 604 the data packet will be discarded (as shown at step 906). At step 918, a determination is made as to whether or not the data packet relates to the destination region the vehicle is heading towards. Not every vehicle that receives a data packet will be able to use the information stored in the data packet. Some vehicles may just function as intermediate nodes within the DTN, receiving data packets from other vehicles and RSUs and forwarding those data packets to other vehicles and RSUs. Such vehicles functioning as intermediate nodes within the DTN do not use the data stored in the data packet. However, if the data packet stores relevant information, then at step 920 the data packet is passed to the AIM.

Returning to step 909, if the trajectory bits are set, i.e., trajectory bits are set within the field 508, then the method proceeds to step 910. If the vehicle that receives the data packet is moving along the trajectory (towards the destination region) indicated within the data packet, then the method proceeds to step 912 and the vehicle sends an ‘ACK’ to the sending vehicle or RSU. If the vehicle is not moving along the trajectory, then the method proceeds to step 918. If the vehicle is not in the destination set, then the method proceeds to step 908, i.e., the packet is discarded. Otherwise, it is passed to the AIM in step 920. The method then returns to idle.

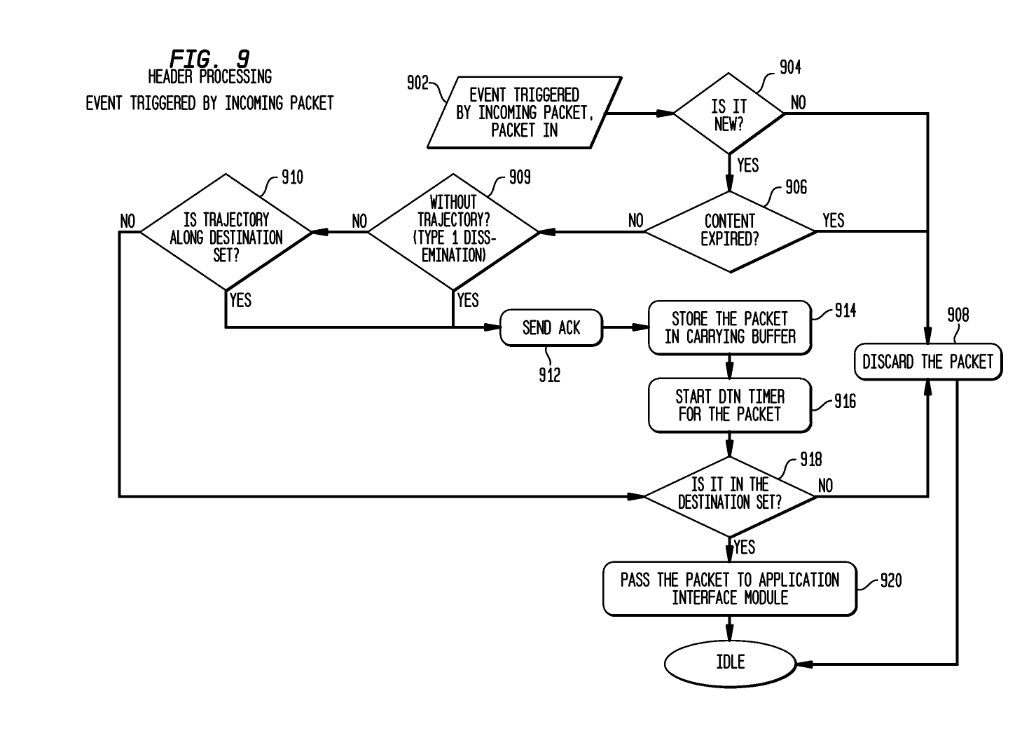

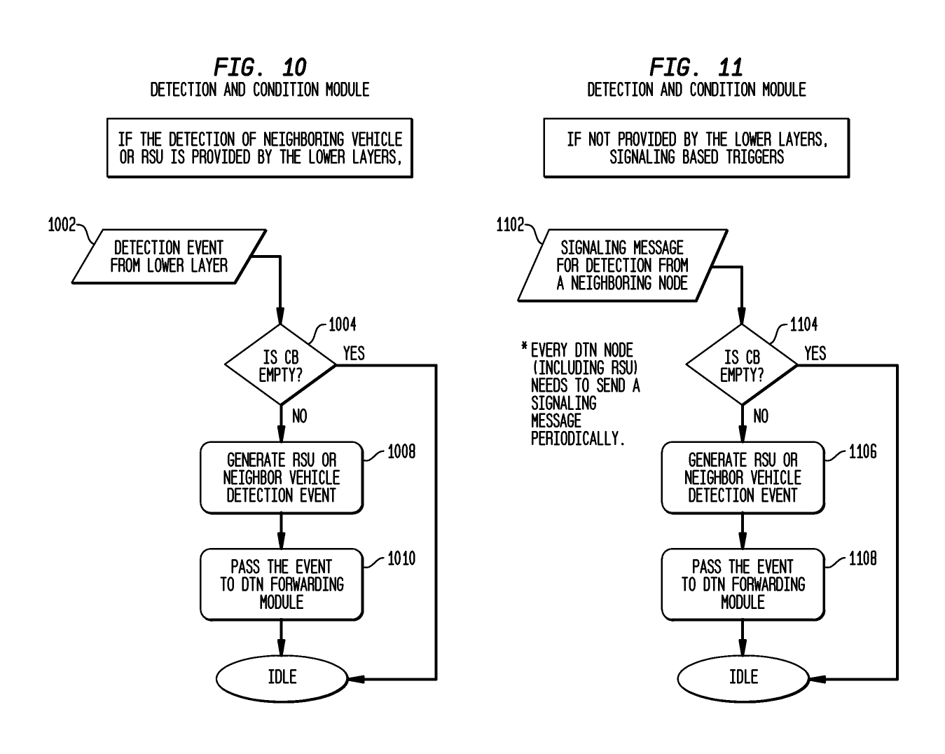

FIG. 10 is a flow diagram of one embodiment of the operation of the condition and detection module. At step 1002, a detection event from a lower layer occurs. At step 1004, a determination is made as to whether or not the carrying buffer 406 is empty. If the carrying buffer 406 is empty, i.e., there are no data packets present in the buffer to forward, then the method ends. However, if there are data packets in the buffer then the method proceeds to step 1008. At step 1008, an RSU or neighbor vehicle detection event is generated. At step 1010, the generated detection event is passed to the DTN forwarding module 409. At step 1010, the DTN forwarding module 409 retrieves one or more appropriate data packets from the carrying buffer and passes the data packet to the network interface which transmits the data packet to the neighbor vehicle or RSU.

FIG. 11 is a flow diagram of an alternate embodiment of the operation of the condition and detection module. At step 1102, a signaling message for detection is received from another (neighboring) vehicle or RSU. Every equipped vehicle and RSU periodically sends out a message or “heartbeat” signal indicating its presence within the LPG (local peer group) network. A discussion of these heartbeat signals and the construction of the LPG network can be found in commonly assigned U.S. patent application Ser. No. 11/285,593 which is incorporated by reference in its entirety. At step 1104, a determination is made as to whether or not the carrying buffer 406 is empty. If the carrying buffer 406 is empty, i.e., there are no data packets present in the buffer to forward, then the method ends. However, if there are data packets in the buffer then the method proceeds to step 1106. At step 1106, an RSU or neighbor vehicle detection event is generated. At step 1108, the generated detection event is passed to the DTN forwarding module 409. The DTN forwarding module 409 retrieves one or more appropriate data packets from the carrying buffer and passes the data packet to the network interface which transmits the data packet to the neighbor vehicle or RSU.

Another possible method for initiating (triggering) transmission and forwarding of a data packet is provided by the method illustrated in FIG. 12. At step 1202, a Periodic DTN Forwarding (PDF) timer expires. At step 1204, a determination is made as to whether or not the carrying buffer 406 is empty. If the carrying buffer 406 is empty then there are no data packets to be forwarded and the method ends. If the carrying buffer 406 is not empty, i.e., the carrying buffer 406 contains one or more data packets, then the method proceeds to step 1206. At step 1206, an RSU or neighbor vehicle detection event is initiated. At step 1208, when a neighbor vehicle or RSU is within the vicinity of a sending node, the DTN forwarding module 409 retrieves one or more appropriate data packets from the carrying buffer and passes the data packet to the network interface which transmits the data packets to the neighbor vehicle or RSU. At step 1210, the PDF timer is restarted. In another embodiment of the architecture, the carrying buffer 406 may be interfaced with a message queue. In some systems, the packets in the carrying buffer 406 are sent to a message queue prior to forwarding over the network interface 316. In such cases, the message queue is reset each time packets from the carry buffer are sent to the message queue.

In one embodiment of the architecture, upon transmission of a data packet within the DTN, the sending node, e.g., vehicle 104 or RSU 108, initiates an ‘ACK’ timer and waits for an ‘ACK’ from a receiving node, e.g., another vehicle or RSU. Receipt of an ‘ACK’ at the sending node is an indication that the data packet has been successfully transmitted to another node within the DTN. The sending node may retransmit the data packet if an ‘ACK’ is not received before the ‘ACK’ timer expires. Once an ‘ACK’ is received, the sending node may continue to broadcast the data packet until a DTN timer determines that the data packet is expired based upon the value stored in the data packet's expiration time field 504. Once a data packet is expired, the data packet is discarded from the carrying buffer 406. In another embodiment of the architecture, upon transmission of a data packet within a DTN, the sending vehicle holds data transmission of the packet to the same vehicle for a pre-specified time duration. This avoids redundant forwarding of the data packet to the same vehicle.

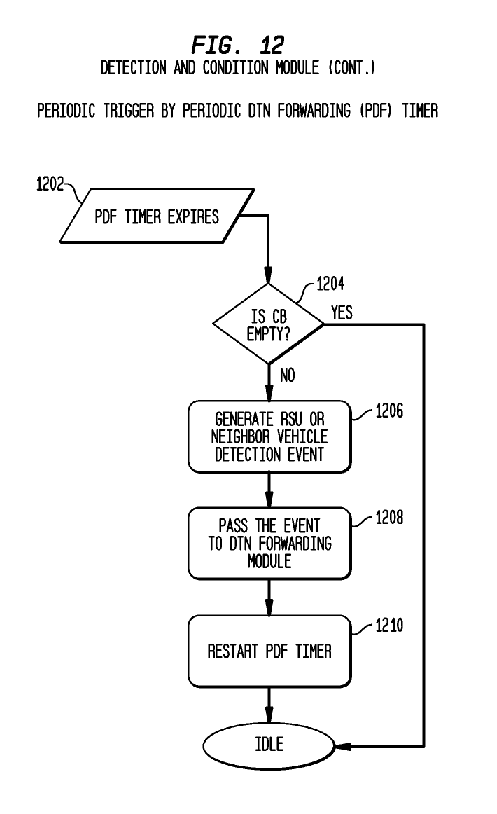

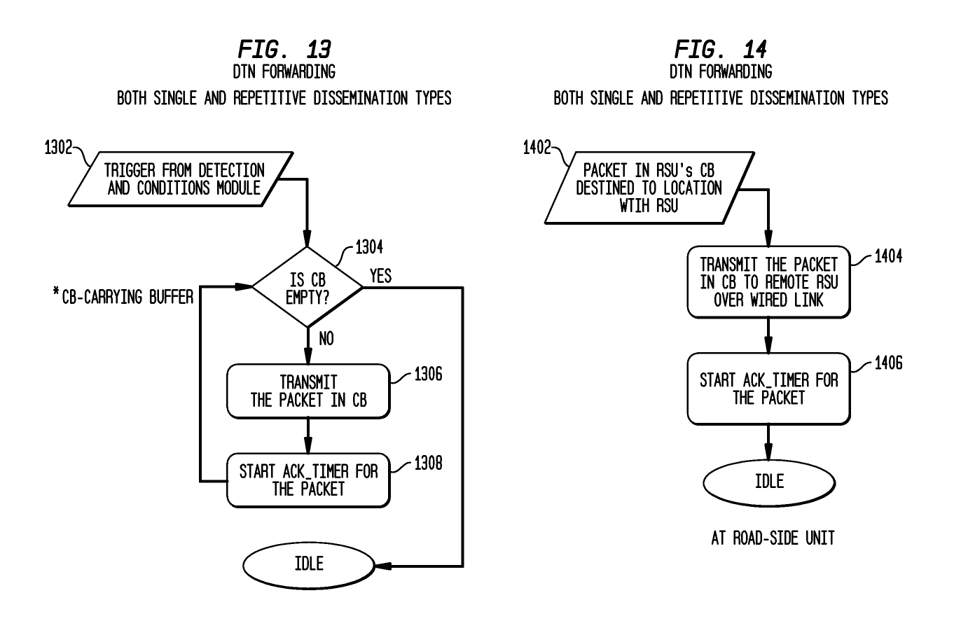

FIG. 13 is a flow diagram for forwarding a data packet from a vehicle. The method begins at step 1302 when a trigger is generated from the detection and conditions module. At step 1304, the carrying buffer 406 is checked to determine if the buffer is empty. If the buffer is not empty, the data packets in the carrying buffer 406 are transmitted at step 1306. At step 1308, an acknowledgement timer for the transmitted data packets is started.

FIG. 14 is a flow diagram of a method for forwarding a data packet from one RSU to another RSU. The method begins at step 1402 when the carrying buffer of an RSU receives a packet that is destined for a location where an RSU is available. At step 1404, the data packet is sent to the remote RSU over a wired link. At step 1406, an acknowledgement timer for the data packet is started at the transmitting RSU.

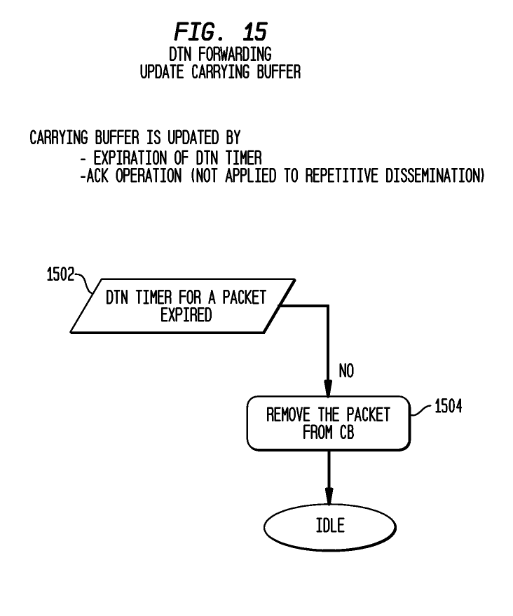

FIG. 15 is a flow diagram of a method for updating the carrying buffer 406. The method begins at step 1502 when a DTN timer 704 for a data packet expires. As shown in FIG. 9, the DTN timer 704 is started at step 916 when a data packet first enters the carrying buffer 406. At step 1504, when the DTN timer 704 expires, the data packet is removed from the carrying buffer 406. Removal of the data packet helps ensure that the carrying buffer 406 does not become full.

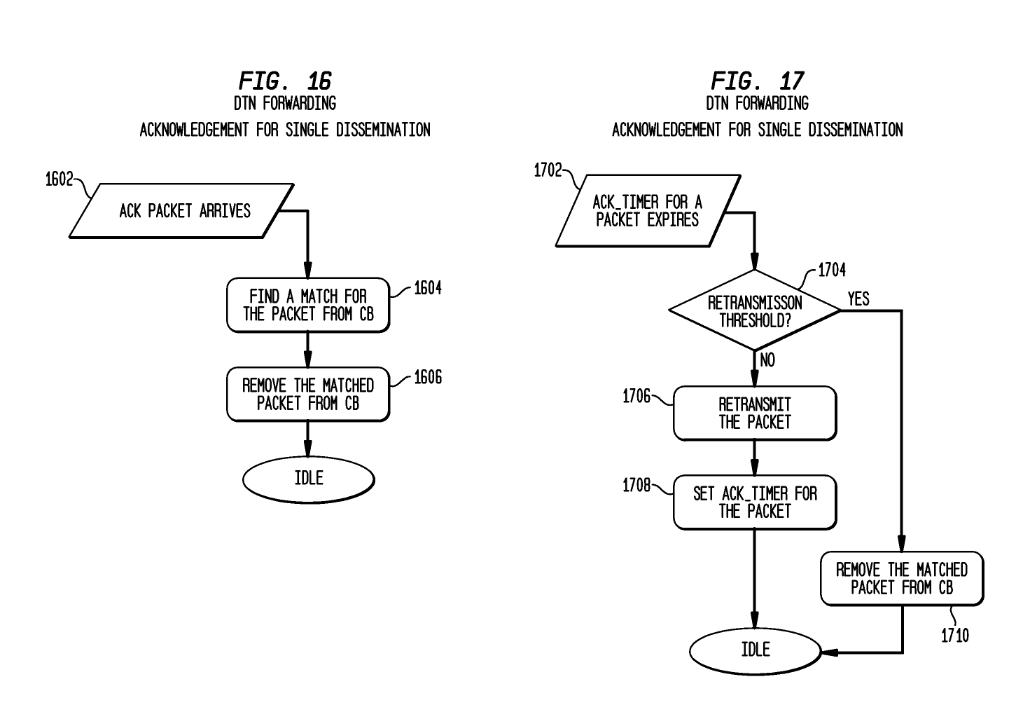

FIG. 16 is a flow diagram of a method for removing a data packet from the carrying buffer 406 once an acknowledgement message arrives. The method only applies to a single-dissemination transmission. The method begins at step 1602 when an acknowledgment message arrives. At step 1604, the acknowledgment message is matched to a data packet stored in the carrying buffer 406. At step 1606, the data packet is marked as acknowledged and the data packet is removed from the carrying buffer 406.

FIG. 17 is a flow diagram of a method for retransmitting a data packet when the acknowledgement timer expires. The method begins at step 1702 when the acknowledgment timer for a single-dissemination data packet expires. At step 1704, a determination is made as to whether the retransmission threshold for the data packet is exceeded. In one embodiment, the retransmission threshold is a certain number of attempts or retries for retransmitting the data packet. If the number of retries has exceeded the retransmission threshold, then the method proceeds to step 1710 and the data packet is removed from the carrying buffer 406. Otherwise, the method proceeds to step 1706 and the data packet is retransmitted. At step 1708, the acknowledgement timer for the retransmitted data packet is started.

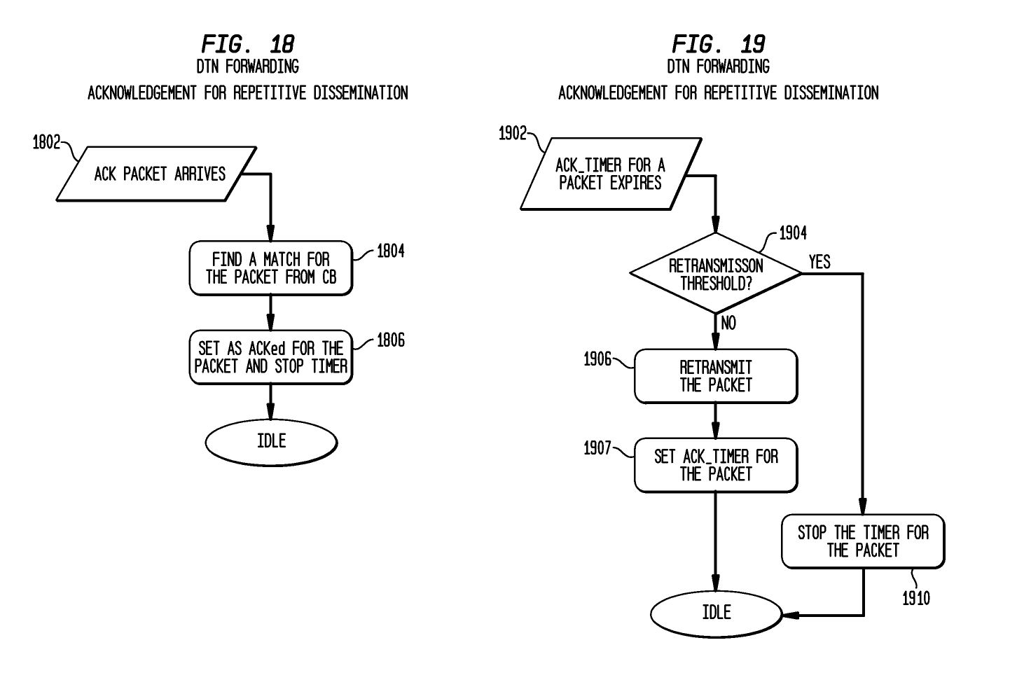

FIG. 18 is a flow diagram of a method for stopping an acknowledgment timer for a data packet when an acknowledgement message arrives for a repetitively forwarded data packet. The method begins at step 1802 when an acknowledgment message arrives. At step 1804, the acknowledgment message is matched to a data packet stored in the carrying buffer 406. At step 1806, the data packet is marked as acknowledged and the acknowledgement timer for the data packet is stopped.

FIG. 19 is a flow diagram of a method for retransmitting a data packet when the acknowledgement timer expires. The method begins at step 1902 when the acknowledgment timer for a data packet expires. At step 1904, a determination is made as to whether the retransmission threshold for the data packet is exceeded. In one embodiment, the retransmission threshold is a certain number of attempts or retries for retransmitting the data packet. If the number of retries has exceeded the retransmission threshold, then the method proceeds to step 1910 and the acknowledgement timer for the packet is stopped. Otherwise, the method proceeds to step 1906 and the data packet is retransmitted. At step 1907, the acknowledgement timer for the retransmitted data packet is started.

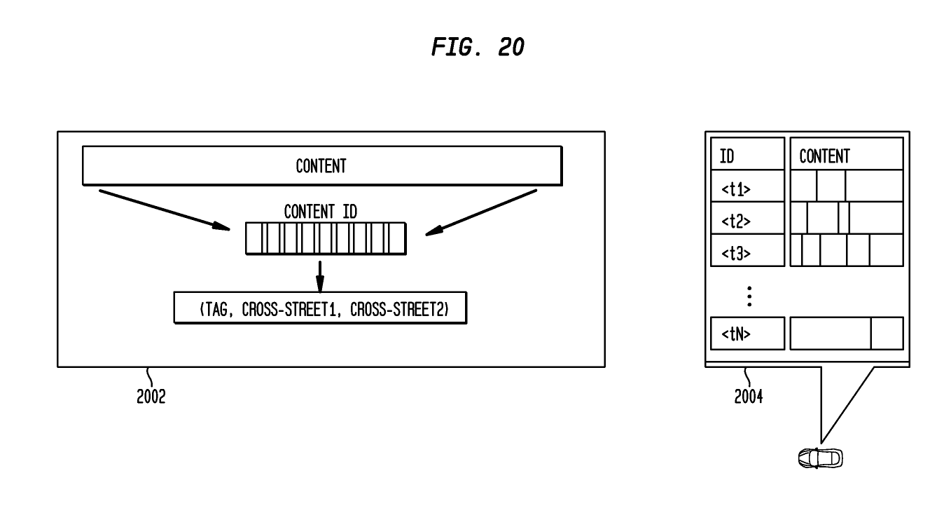

FIG. 20 is an example of how tags may be used for content anchoring. Content anchoring refers to the process of keeping information (content) within a certain geographical region for possible future use. The content is either stored in the memory of an RSU or in the carrying buffer of the vehicles that are traveling within the given geographical region. For example, within each geographical region of interest, each vehicle that has the content stored in its carrying buffer disseminates packets with the content in non-trajectory mode as long as the vehicle remains within the geographical region of interest. This approach increases the likelihood of having the content available to other nodes, i.e., vehicles and RSUs, within the geographical region of interest. The content may consist of information about traffic congestion, local events, transit updates, etc. Such content may be accessed based on appropriately named tags. The content identifiers, as in 2002, could be the name of the cross streets comprising an intersection appended to the word traffic which is the tag, e.g., traffic-crosstreet1-crosstreet2. Road condition information could be identified as condition-crosstreet1-crosstreet2, etc. Such information may prove useful for driving assistance. Accordingly, the information may be indexed at a vehicle as shown in 2004 to cater to requests from other vehicles.

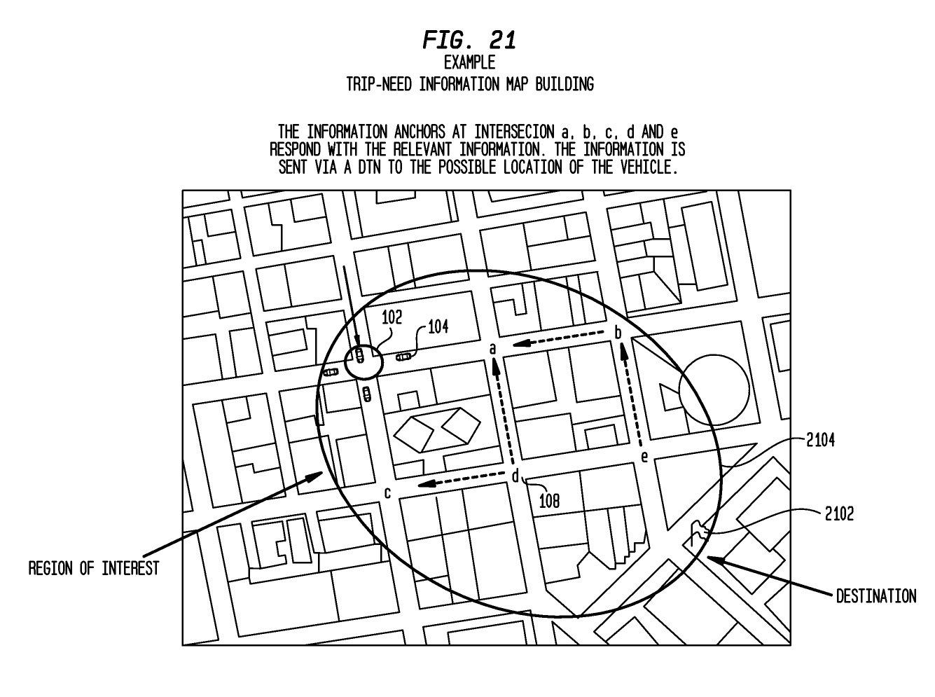

FIG. 21 is an example of how a vehicle, e.g., vehicle 102, may utilize the present invention. Vehicle 102 is traveling along a path towards a destination 502. The region of interest 504 is contained within oval 2104 as shown. Vehicle 102 employs a dashboard computer that utilizes the architecture described and shown in FIGS. 3 and 4 as above. Vehicle 104 may be equipped with a dashboard computer capable of wireless communication with vehicle 102. Vehicle 102 may initiate a request for information pertaining to region 504. For example, vehicle 104 may disseminate a request for traffic information from the other vehicles and roadside units within the region 504. Upon receipt of the request for traffic information, other vehicles and roadside units within region 504 respond to the request and pass data packets with traffic information back to vehicle 102. Vehicle 102 may then utilize the information stored in these data packets to plan an optimal route (trajectory) towards destination 2102. In one embodiment, the information from the data packet is processed at the header processing module 407 and stored in the carrying buffer 406 (as shown in FIG. 4). The data packet may then be optimized at the content optimization sub-layer 312 as discussed above. In another embodiment, the header processing module 407 parses the data packet, determines the data packet may be utilized by an application such as mapping software, and directly forwards the data packet to an application interface module 402 within the context handling sub-layer 310.

Data packets may also be provided to vehicle 102 by RSU 108. For example, an RSU 108 may be present at point ‘b’. The RSU 108 is capable of transmitting data packets containing relevant information about traffic congestion and roadway conditions to vehicle 104, which then in turn, retransmits the data packet to vehicle 102.

FIG. 22 is one embodiment of a dashboard computer which can benefit from the present invention. The dashboard computer 2202 comprises a processor (CPU) 2204, a transceiver 2206 (which in one embodiment is incorporated into the network interface 316), and a memory 2208. The dashboard computer 2202 is coupled to the transceiver 2206 and the memory 2208 and executes application programs stored in memory such as “mapping software” 2214. The transceiver 2206 enables wireless (RF) communication between the vehicles and RSUs, e.g., vehicles 102 and 104 and RSU 108. In one embodiment, vehicles communicate with each other via the 802.11a wireless communications standard. It is understood that the invention may use any wireless communication standard. Other components commonly found within a dashboard computer 1802, such as a power source, an antenna, a storage unit, and various support circuitry are understood to be present, but not shown in FIG. 22.

The memory 2208 may include random access memory, read only memory, removable disk memory, flash memory, and various combinations of these types of memory. The memory 2208 is sometimes referred to as a main memory and may in part be used as cache memory. The memory 2208 stores at least one application, such as the “mapping software” 2214 and an operating system (OS) 2210. The OS 2210 utilizes the software protocols shown in FIGS. 3 and 4, and described in greater detail above, to manage the receipt and transmission of data packets in accordance with a context-based DTN.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The terminology used herein is for the purpose of describing particular embodiments only and is not intended to be limiting of the invention. As used herein, the singular fauns “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, or server. A module may be a component of a device, software, program, or system that implements some “functionality”, which can be embodied as software, hardware, firmware, electronic circuitry, or etc.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

1. A computer implemented method for communicating data within a disruption tolerant network comprising:
receiving a data packet, said data packet including a context;
storing the data packet to a buffer;
disseminating the data packet to a neighboring vehicle or a road side unit according to the information in the context; and
passing the data packet to an application when the context of the data packet matches an application context, said application associated with said application context.

2. The method of claim 1 wherein said data packet is a first data packet, further comprising:
comparing the first data packet to a second data packet stored in the buffer; and
when the context of the first data packet matches the context of the second data packet, comparing the state of the first data packet to a state of the second data packet, and when the states differ, averaging the states together to form a new data packet including the context of the first data packet and the averaged state, and storing the new data packet in the buffer.

3. The method of claim 1 further comprising, discarding the data packet when the context does not match the application context.

4. The method of claim 1 further comprising providing an acknowledgment message to a sender of said data packet when the context matches the application context.

5. The method of claim 1 further comprising:
associating said data packet with a geographic region; and
rebroadcasting said data packet to one or more vehicles or to one or more roadside units within the geographic region in a non-trajectory mode to increase availability of the content at nodes within the geographic region.

6. The method of claim 1 further comprising:
associating the data packet with a destination; and
rebroadcasting the data packet to one or more vehicles in a trajectory mode, wherein the one or more vehicles that receive the data packet store the data packet to the buffer only if the one or more vehicles are moving along a trajectory towards the destination, otherwise discarding the data packet.

7. The method of claim 1, further comprising:
sending a request from a requestor vehicle for traffic information to one or more vehicles or roadside units within a region by disseminating a request for the traffic information among the one or more vehicles or roadside units;
upon receipt of the request at the one or more vehicles or roadside units, sending data packets with the traffic information from the one or more vehicles or roadside units to the requestor vehicle; and
upon receiving the data packets with the traffic information at the requestor vehicle, passing the data packets to the application.

8. The method of claim 7, wherein the application is a traffic map building application that utilizes the traffic information to plan a trajectory from a current location to a destination point.

9. The method of claim 1, wherein the context comprises at least one of an event, a level of traffic congestion, a road condition, a vehicle trajectory, a destination, and a geographical region of interest.

10. A computer program product for communicating data within a disruption tolerant network comprising:
a storage medium readable by a processor and storing instructions for operation by the processor for performing a method comprising:
receiving a data packet, said data packet including a context;
storing the data packet to a buffer;
disseminating the data packet to a neighboring vehicle or a road side unit according to the information in the context; and
passing the data packet to an application when the context of the data packet matches an application context, said application associated with said application context.

11. The computer program product of claim 10 wherein said data packet is a first data packet, further comprising:
comparing the first data packet to a second data packet stored in the buffer; and
when the context of the first data packet matches the context of the second data packet, comparing the state of the first data packet to a state of the second data packet, and when the states differ, averaging the states together to form a new data packet including the context of the first data packet and the averaged state, and storing the new data packet in the buffer.

12. The computer program product of claim 10 further comprising discarding the data packet when the context does not match the application context.

13. The computer program product of claim 10 further comprising providing an acknowledgment message to a sender of said data packet when the context matches the application context.

14. The computer program product of claim 10 further comprising associating said data packet with a geographic region; and
rebroadcasting said data packet to one or more vehicles or to one or more roadside units within the geographic region in a non-trajectory mode to increase availability of the content at nodes within the geographic region.

15. The computer program product of claim 10, wherein the context comprises at least one of an event, a level of traffic congestion, a road condition, a trajectory, a destination, and a geographical region of interest.

16. The computer program product of claim 10 further comprising:
associating the data packet with a destination; and
rebroadcasting the data packet to one or more vehicles in a trajectory mode, wherein the one or more vehicles that receive the data packet store the data packet to the buffer only if the one or more vehicles are moving along a trajectory towards the destination, otherwise discarding the data packet.

17. The computer program product of claim 10 further comprising:
sending a request from a requestor vehicle for traffic information to one or more vehicles or roadside units within a region by disseminating a request for the traffic information among the one or more vehicles or roadside units;
upon receipt of the request at the one or more vehicles or roadside units, sending data packets with the traffic information from the one or more vehicles or roadside units to the requestor vehicle; and
upon receiving the data packets with the traffic information at the requestor vehicle, passing the data packets to the application.

18. The computer program product of claim 10, wherein the application is a traffic map building application that utilizes the traffic information to plan a trajectory from a current location to a destination point.

19. An apparatus comprising a processor and a memory, wherein the processor executes one or more programs stored in the memory, the processor operable to receive a data packet, said data packet including a context and a state related to said context, store the data packet to the memory when the context matches an application context, disseminating the data packet to a neighboring vehicle or road side unit according to the information in the context, and pass said data packet to an application when the context matches an application context, said application associated with said application context.

20. The apparatus of claim 19 wherein said data packet is a first data packet, the processor further operable to compare the first data packet to a second data packet stored in the memory, and when the context of the first data packet matches the context of the second data packet, compare the state of the first data packet to a state of the second data packet, and when the states differ, averaging the states together to form a new data packet including the context of the first data packet and the averaged state, and storing the new data packet in the buffer.

21. The apparatus of claim 19, the processor further operable to provide an acknowledgment message to a sender of said data packet when the context matches the application context.

22. The apparatus of claim 19, the processor further operable to associate said data packet with a geographic region and rebroadcast said data packet to one or more vehicles or to one or more roadside units within the geographic region in a non-trajectory mode to increase availability of the content at nodes within the geographic region.

23. The apparatus of claim 19, the processor further operable to associate the data packet with a destination and rebroadcast the data packet to one or more vehicles in a trajectory mode, wherein the one or more vehicles that receive the data packet store the data packet to the buffer only if the one or more vehicles are moving along a trajectory towards the destination, otherwise discarding the data packet.

24. The apparatus of claim 19, the processor further operable to send a request from a requestor vehicle for traffic information to one or more vehicles or roadside units within a region by disseminating a request for the traffic information among the one or more vehicles or roadside units, and upon receiving data packets with the traffic information at the requestor vehicle, passing the data packets to a traffic map building application that utilizes the traffic information to plan a trajectory from a current location to a destination point.
